(19) United States
(12) Patent Application Publication
(10) Pub. No.: US 2006/0171422 A1
(43) Pub. Date: Aug. 3, 2006

(54) Method for realizing transmitting quasi-together the voice service and data service

(76) Inventors: Yuhong Xue, Shenzhen City (CN); Jiazhou Chen, Shenzhen City (CN)

Correspondence Address: FARJAMI & FARJAMI LLP, 26522 LA ALAMEDA AVENUE, SUITE 360, MISSION VIEJO, CA, 92691, US

(21) Appl. No.: 10/547,712

(22) PCT Filed: Dec. 18, 2003
(86) PCT No.: PCT/CN03/01084

§ 371 Date: Aug. 30, 2005

(30) Foreign Application Priority Data
Apr. 25, 2003 (CN) 03113336.3

(51) Int. Cl. H04J 3/00

(52) U.S. Cl. 370/521; 370/201; 370/352

(57) ABSTRACT

The present invention discloses a method for realizing voice preference over packet data service and voice service in a CDMA system, comprising: when a mobile station is in a data service call, transmitting a message that indicates there is a voice service to the mobile station if a mobile switching center has detected a voice service that directed to the mobile station; switching the mobile station from the data service call to the voice service to realize voice preference over packet data service and voice service. The method provided by the invention for realizing voice preference over packet voice and data service can provide maximum flexibility and allows a user to make selection based on specific situation to decide whether to answer a new voice call, thereby satisfying user's needs to the largest extent.

### TECHNICAL FIELD OF THE INVENTION

The present invention relates to mobile communication system, in particular, to a method for realizing voice preference over packet voice and data service in a CDMA system.

### BACKGROUND OF THE INVENTION

At present, China's CDMA network employs CDMA2000 Release 0 version, which does not support concurrent processing of both data and voice service, that is, when a user is making a high-speed packet data call, the system does not support the user to answer voice call at the same time. Although mobile communication service has gradually placed emphasis on high-speed packet data service, traditional voice service is still the predominant service at present, the system needs to be modified and changed a lot to realize concurrent voice service and data service, which will significantly influence the operator's investment benefit.

### SUMMARY OF THE INVENTION

The technical problem to be solved by the invention is that in an existing CDMA system, a user cannot answer voice service when he/she is receiving data service, the system does not support voice preference over packet voice service and data service, in view of the above, the invention provides a method for realizing voice preference over packet voice service and data service.

The technical solution taken to realize the purpose of the invention is summarized as follows:

a method for realizing voice preference over packet data service and voice service in a CDMA system, comprising: transmitting a message that indicates there is a voice service to a mobile station if a mobile switching center has detected a voice service that directed to the mobile station when the mobile station is in a data service call; switching the mobile station from the data service call to the voice service to realize voice preference over packet data service and voice service.

Preferably, after said step of transmitting a message that indicates there is a voice service to the mobile station, further comprising: prompting the user that there is a voice service to access by the mobile station based on the message that indicates there is a voice service to make the user select whether to answer the voice service; determining whether to switch the mobile station from the data service call to the voice service by the mobile switching center based on the user's selection.

Preferably, said step of the user selecting whether to answer the voice service comprising: sending an answer message from the mobile station to the mobile switching center if the user selects to answer the voice service.

Preferably, the mobile station is connected to a packet data servicing node, said step of switching mobile station from data service to voice service further comprising: issuing a release command to a base station controller by the mobile switching center to release the mobile station's data service flow; performing release flow for the mobile station's data service and making the connection between the mobile station and the packet data servicing node enter into a hibernate state by the base station controller; initiating a paging request of the voice service to the mobile station by the mobile switching center, the mobile station enters into ordinary voice service state.

Preferably, said step of switching mobile station from data service to voice service further comprising: initiating a release flow for the mobile station's voice service by the mobile switching center when the mobile station's voice service is complete.

Preferably, on the basis of the cause value of the release command in the original IOS standard, the cause value in the release command adds a cause value for the release of voice preference over packet data service and voice service; the added cause value for the release of voice preference over packet data service and voice service in the release command is 7C.

Preferably, the release flow of the data service further comprising: receiving a release command that contains the cause value for the release of voice preference over packet data service and voice service from the mobile switching center and sending a retry command at a service channel to the mobile station by the base station controller; sending a release instruction to the mobile station by the mobile switching center to release air resource; sending a release confirmation message to the base station controller by the mobile station; sending a release completion message to the mobile switching center by the base station controller.

Preferably, the release flow of the data service further comprising: receiving a release command that contains the cause value for the release of voice preference over packet data service and voice service from the mobile switching center and sending a service option control message at a service channel to the mobile station by the base station controller; sending a release instruction to the mobile station by the base station controller to release air resource; sending a release confirmation message to the base station controller by the mobile station; sending a release completion message to the mobile switching center by the base station controller.

Preferably, the message that indicates there is a voice service is a FWI message; the FWI message can have a caller number therein; the answer message can be a blank FWI message.

The method provided by the invention for realizing voice preference over packet voice and data service can provide maximum flexibility and allows a user to make selection based on specific situation to decide whether to answer a new voice call, thereby satisfying user's needs to the largest extent.

### BRIEF DESCRIPTION OF THE DRAWINGS

FIG. 1 is a flowchart of the method provided by the invention for realizing voice preference over packet data service and voice service.

### DETAILED DESCRIPTION OF THE PREFERRED EMBODIMENTS

Next, the present invention will be described in detail in conjunction with accompany drawing and the implementation.

In the existing CDMA network, the widely employed standard version is CDMA2000 release 0, which has a defect in that when a user is transmitting or receiving data service, if there is a voice service call, the user must wait for the completion of the data service to answer the call. Therefore, the present invention has proposed a concept of “voice preference over packet” voice and data service, that is: when a user is using data service, if there is a voice call that accessed in, then the data service in use will be paused to access the voice call, when the user completes the call, the system will restore the original data service.

A data service model can be divided into three states: idle, hibernate and active. These states can convert to each other, but as to the present solution, mainly it is the situation that a mobile phone is in an active state. According to protocol specification, generally there are three types of release flow for the data service under active state: MS initiated, PDSN initiated and BSC initiated. In the voice preference over packet method of the invention, the release is initiated by a MSC to release the data service from an active state to a hibernate state.

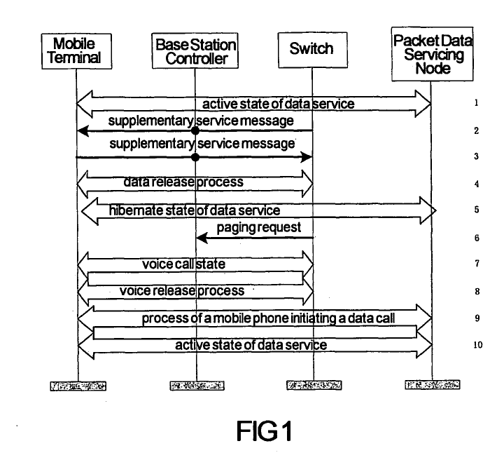

As shown in FIG. 1, the CDMA system of the invention comprises a mobile station (MS), a base station controller (BSC), a packet data servicing node (PDSN) and a mobile switching center (MSC), said method comprising: when the connection between the MS and the PDSN is in an active state, if the MSC has detected a voice service, then it sends to the MS a FWI message, i.e. Flash With Information, the message can have a caller number therein, so that a user can select whether to answer the voice call; if the user selects to answer the voice service, then the MS sends to the MSC an answer message, this message can be a blank FWI message; after the MSC has received the answer message from the MS, it initiates to the BSC a release command for the data service, the release command is a message that modifies the existing release command (CLEAR COMMAND), a cause value is added in the Cause Value of the message, that is, add a cause value (e.g. 7C) for voice preference over packet release in Cause Value of the IOS standard. The voice preference over packet service, as a newly added service, when the MSC is sending a release command to the BSC, if a new cause value is added in the CLEAR COMMAND, then the interaction between the MSC and the BSC will become more clear, and there won't be any ambiguity. Further, 7C is a brand-new cause value which has never been adopted in the IOS standard, so it is even harder to bring any ambiguity. When the BSC has received the CLEAR COMMAND with that cause value sent from the MSC, it is clear that now is a voice preference over packet situation. After the release flow has been completed, the MS sends a release confirmation message to the BSC, and the BSC sends a release completion message to the MSC.

After the BSC has received the release command initiated by the MSC, it performs normal release flow and at the same time, interacts with the MS to make the MS change from active state to hibernate state to wait for a paging message. However, according to the existing protocol specification, if a MS is uploading data, then after forcing the MS to transition to hibernate state, the MS will again initiate new data call and its state will change from hibernate state to active state, at this time, even if a MSC issues a paging message to establish a voice call flow, since the state of the MS has transitioned to an active state, the MS won't accept that paging message. To avoid this, the BSC instructs the MS to stay for a small period of time after entering into hibernate state in order to leave some time for the MSC to call the MS, the invention employs two solutions to implement this: one is that the BSC sends a Retry Order to the MS to let the MS initiate a call after delaying a small period of time. The second is that the BSC sends a Service Option Control message, which can set the waiting time after the MS has entered into hibernate state.

After the connection between the MS and the PDSN has entered into hibernate state, the MSC initiates a call request for the voice service; the MS enters into ordinary voice service state and when the voice service is over, the MSC initiates a release flow for the voice service; when the MS receives or sends data service, the connection between the MS and the PDSN will enter from hibernate state into active state.

On the basis of the existing supplementary service, the present invention adds a new type of supplementary service, namely, voice service first. This type of supplementary service allows a user to first select voice service when there is concurrent data service and voice service. This type of supplementary service can be activated or deactivated by user by calling a special number. The user can select in real time whether to activate or deactivate this kind of service based on his/her own time period and schedule.

1. A method for realizing voice preference over packet data service and voice service in a CDMA system, wherein, comprising:
transmitting a message that indicates there is a voice service to a mobile station if a mobile switching center has detected a voice service that directed to the mobile station when the mobile station is in a data service call;
switching the mobile station from the data service call to the voice service to realize voice preference over packet data service and voice service.

2. The method of claim 1, wherein, after said step of transmitting a message that indicates there is a voice service to the mobile station, further comprising:
prompting the user that there is a voice service to access by the mobile station based on the message that indicates there is a voice service to make the user select whether to answer the voice service;
determining whether to switch the mobile station from the data service call to the voice service by the mobile switching center based on the user's selection.

3. The method of claim 1, wherein, the message that indicates there is a voice service is a FWI message.

4. The method of claim 2, wherein, said step of the user selecting whether to answer the voice service comprising:
sending an answer message from the mobile station to the mobile switching center if the user selects to answer the voice service.

5. The method of claim 1, wherein, the mobile station is connected to a packet data servicing node, said step of switching mobile station from data service to voice service further comprising:
issuing a release command to a base station controller by the mobile switching center to release the mobile station's data service flow;
performing release flow for the mobile station's data service and making the connection between the mobile station and the packet data servicing node enter into a hibernate state by the base station controller;
initiating a paging request of the voice service to the mobile station by the mobile switching center, the mobile station enters into ordinary voice service state.

6. The method of claim 5, wherein, said step of switching mobile station from data service to voice service further comprising:
initiating a release flow for the mobile station's voice service by the mobile switching center when the mobile station's voice service is complete.

7. The method of claim 5, wherein, on the basis of the cause value of the release command in the original IOS standard, the cause value in the release command adds a cause value for the release of voice preference over packet data service and voice service.

8. The method of claim 7, wherein, the added cause value for the release of voice preference over packet data service and voice service in the release command is 7C.

9. The method of claim 7, wherein, the release flow of the data service further comprising:
receiving a release command that contains the cause value for the release of voice preference over packet data service and voice service from the mobile switching center and sending a retry command at a service channel to the mobile station by the base station controller;
sending a release instruction to the mobile station by the mobile switching center to release air resource;
sending a release confirmation message to the base station controller by the mobile station;
sending a release completion message to the mobile switching center by the base station controller.

10. The method of claim 7, wherein, the release flow of the data service further comprising:
receiving a release command that contains the cause value for the release of voice preference over packet data service and voice service from the mobile switching center and sending a service option control message at a service channel to the mobile station by the base station controller;
sending a release instruction to the mobile station by the base station controller to release air resource;
sending a release confirmation message to the base station controller by the mobile station;
sending a release completion message to the mobile switching center by the base station controller.

11. The method of claim 3, wherein, the FWI message can have a caller number therein.

12. The method of claim 4, wherein, the answer message can be a blank FWI message.

13. The method of claim 8, wherein, the release flow of the data service further comprising:
receiving a release command that contains the cause value for the release of voice preference over packet data service and voice service from the mobile switching center and sending a retry command at a service channel to the mobile station by the base station controller;
sending a release instruction to the mobile station by the mobile switching center to release air resource;
sending a release confirmation message to the base station controller by the mobile station;
sending a release completion message to the mobile switching center by the base station controller.

14. The method of claim 8, wherein, the release flow of the data service further comprising:
receiving a release command that contains the cause value for the release of voice preference over packet data service and voice service from the mobile switching center and sending a service option control message at a service channel to the mobile station by the base station controller;
sending a release instruction to the mobile station by the base station controller to release air resource;
sending a release confirmation message to the base station controller by the mobile station;
sending a release completion message to the mobile switching center by the base station controller.
